(19) United States
(12) Patent Application Publication
(10) Pub. No.: US 2008/0052336 A1
(43) Pub. Date: Feb. 28, 2008

(54) Method and Apparatus for Providing FFT-Based Signal Processing with Reduced Latency

(76) Inventors: Andre Kaufmann, Bochum (DE); Thao Bui, Mulheim (DE); Martin Kosakowski, Bochum (DE); Ernst Zielinski, Dortmund (DE); Chandra Gupta, Bochum (DE)

Correspondence Address: DITTHAVONG MORI & STEINER, P.C., 918 Prince St., Alexandria, VA, 22314, US

(21) Appl. No.: 11/737,194

(22) Filed: Apr. 19, 2007

(30) Foreign Application Priority Data
Aug. 22, 2006 (EP) 06 017 463.8

(51) Int. Cl. G06F 17/14

(52) U.S. Cl. 708/404

(57) ABSTRACT

An approach is provided for reducing latency in fast Fourier transformation (FFT) related systems, such as orthogonal frequency division multiplexing (OFDM) systems. In a first processing direction, an interleaving processing is performed to obtain an interleaved data sequence which is then subjected to an inverse fast Fourier transformation processing, wherein the interleaving processing comprises a bit re-ordering processing of the inverse fast Fourier transformation processing. In an opposite second processing direction, a fast Fourier transformation processing is performed with a bit-reversed output data sequence which is then subjected to a de-interleaving processing, wherein the de-interleaving processing comprises a bit re-ordering processing required for re-ordering said bit-reversed output data sequence. The combined interleaving/de-interleaving and reordering processing leads to a reduced latency and saves memory space.

### FIELD OF THE INVENTION

The invention, according to various embodiments, relates to communications, and particularly, to signal processing.

### BACKGROUND OF THE INVENTION

Many current communication systems are based on Orthogonal Frequency Division Multiplexing (OFDM) and related technologies. The Fourier transformation of a signal from time domain into frequency domain and vice versa is one of the most important processing modules in such systems. The fast Fourier transform (FFT) is an efficient transformation algorithm. In general, FFTs are of great importance to a wide variety of other applications as well, e.g., digital signal processing for solving partial differential equations, algorithms for quickly multiplying large integers, and the like.

In OFDM systems, which also include interleaving, like in WLANs (wireless local area networks) but also in WiMAX (worldwide interoperability for microwave access), heavy latency requirements are posed on receiver implementations, due to the needed short turn-around times, e.g., for sending acknowledgements. In WLAN and similar systems the checking of a received burst and acknowledging has to be done in a short time (known as Short Inter Frame Space (SIFS) time). A conventional FFT, together with a de-interleaver, will introduce a delay of three OFDM symbols, because for each of the both operations a complete symbol needs to be collected, before the operations can start. The FFT would require an additional symbol delay for reordering the results. This causes heavy latency requirements for the rest of the receiver chain. Furthermore, both functions need memory to store the received symbols. The same is valid for the transmitter side, where inverse FFT (IFFT) and interleaver are involved.

### SUMMARY OF THE INVENTION

Therefore, there is a need to provide an improved FFT-based signal processing scheme, by means of which memory requirements and processing latency can be reduced.

According to an embodiment of the invention, a signal processing method comprises:
performing an interleaving processing to obtain an interleaved data sequence; and
subjecting said interleaved data sequence to an inverse fast Fourier transformation processing;
wherein said interleaving processing comprises a bit re-ordering processing of said inverse fast Fourier transformation processing.

According to another embodiment of the invention, a signal processing module comprises:
interleaving means for performing an interleaving processing to obtain an interleaved data sequence; and
transformation means for subjecting said interleaved data sequence to an inverse fast Fourier transformation processing;
wherein said interleaving means are configured to perform a bit re-ordering processing of said inverse fast Fourier transformation processing.

According to another embodiment of the invention, a signal processing method comprises:
performing a fast Fourier transformation processing with a bit-reversed output data sequence; and
subjecting said output data sequence to a de-interleaving processing;
wherein said de-interleaving processing comprises a bit re-ordering processing required for reordering said bit-reversed output data sequence.

According to another embodiment of the invention, a signal processing module comprising:
transformation means for performing a fast Fourier transformation processing with a bit-reversed output data sequence; and
de-interleaving means for subjecting said output data sequence to a deinterleaving processing;
wherein said de-interleaving means are configured to perform a bit reordering processing required for reordering said bit-reversed output data sequence.

Accordingly, no reordering is performed in the IFFT or FFT processing, but it is combined with the interleaver or de-interleaver functionality. Through this measure, the delay of these two modules or processing functions can be reduced to two symbols and also memory requirements can be minimized.

The bit re-ordering processing may be performed by modifying a memory table. In a specific implementation example, the modification may be directed to an address generation for addressing the memory table. This means just a simple modification of the memory table.

According to yet another embodiment of the invention, a computer program products comprises code means for producing the above method steps when run on a computer device.

The above signal processing modules refer to units which can be traded separately but which may exclude other parts or components to be added by end manufacturers. They may be implemented as chip devices (e.g., integrated circuits (ICs) or the like), which can be connected to other stages or components of the respective final apparatus, e.g., transmission or receiving apparatus. Further advantageous modifications are described in the dependent claims.

### BRIEF DESCRIPTION OF THE DRAWINGS

The invention will now be described in greater detail based on various embodiments with reference to the accompanying drawings, in which:

FIG. 1 shows a schematic block diagram of an OFDM system, according to one embodiment of the invention;

FIG. 2 shows a schematic signal flow graph of an FFT stage, according to one embodiment of the invention;

FIG. 3 shows a schematic block diagram of an interleaver or de-interleaver stage, according to one embodiment of the invention;

FIG. 4 shows a schematic block diagram of a computer-based implementation of an embodiment of the invention;

FIG. 5 shows a basic flow diagram of a transmitter processing, according to one embodiment of the invention; and

FIG. 6 shows a basic flow diagram of a receiver processing, according to one embodiment of the invention.

### DETAILED DESCRIPTION OF THE PREFERRED EMBODIMENTS

In the following, the invention, according to certain embodiments, will be described in connection with an exemplary OFDM transmission system.

A computationally demanding operation in an OFDM transmitter, receiver or transceiver is the FFT or IFFT calculation, respectively. When designing an FFT, area is traded against speed. An efficient option to implement an FFT is to use a timeshared butterfly (where the term “butterfly” indicates the shape of the processing stage) and a memory. However, this approach involves the draw-backs of large latency and low throughput. Latency is critical if the system is designed for real-time applications, which is to be expected in OFDM systems. To decrease latency and increase throughput, a pipelined FFT architecture can be used. A drawback thereof is that the required amount of hardware is increased, mostly due to extra multipliers.

In connection with FFT or IFFT processing, bit reversed sequences are processed or generated. The term “bit reversed” is used to indicate that the addresses needed to access the sequence in correct order are the normal binary addresses read backwards, i.e., right to left. For example, this means that the binary address “110” (which corresponds to the decimal address “6”) becomes the binary address “011” (which corresponds the decimal address “3”). The above mentioned pipelined FFTs have the property that the output sequence is bit reversed compared to the input sequence. Depending on the architecture, a pipelined FFT will either produce the output sequence in bit reversed order or use the input sequence in bit reversed order.

A pipelined FFT can be implemented either as a decimation in time (DIT) or as a decimation in frequency (DIF). The difference is whether the multiplication is performed first (DIT) or last (DIF) in the butterfly. No matter whether a DIT or DIF approach is used for the FFT, the sequence should be transmitted in the correct order over the channel, i.e. the IFFT output should be transmitted in correct order. One method to solve the bit reversing in pipelined FFTs is to add a buffer before or after the FFT processor that can reorder the Sequence. However, as indicated in the introductory part, this will increase both hardware and delay.

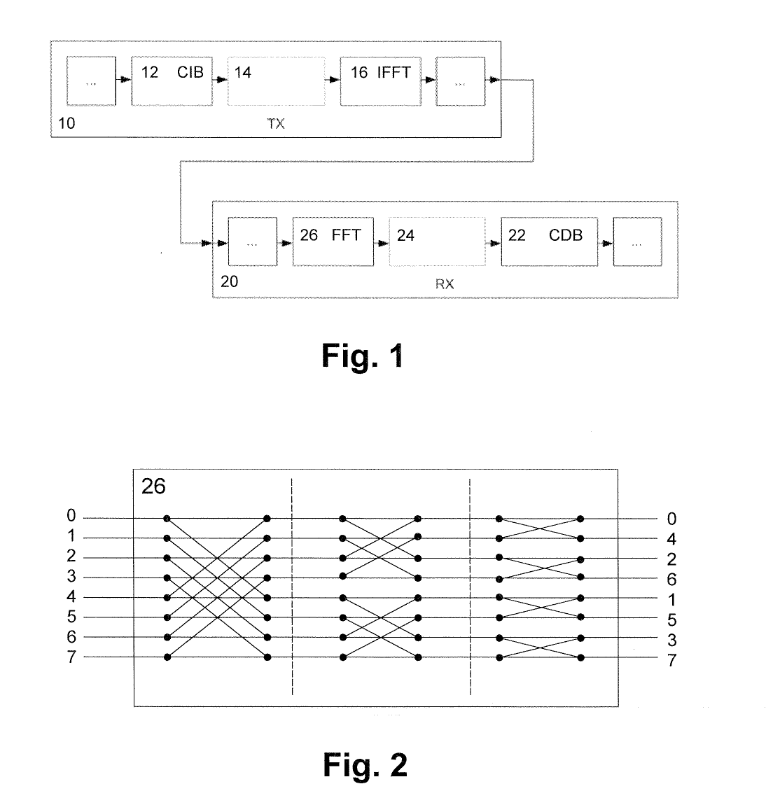

FIG. 1 shows a schematic functional block diagram of an OFDM system according to one embodiment of the invention with a transmitter 10 and a receiver 20. Although the connection between the transmitter 10 and receiver 20 is indicated in FIG. 1 as a wired connection, it may of course be implemented as a wireless connection (such as for example in a WLAN system).

The OFDM system is implemented using a combination of an FFT stage 26 in the receiver 20 and a mathematically equivalent IFFT stage 16 in the transmitter 10. The OFDM system treats the source symbols at the input of the transmitter 10 as though they are in the frequency domain. These symbols are processed in some preceding stages, including a combined interleaving and bit reordering stage 12 and other operations 14 and are then used as inputs to the IFFT stage 16 which transforms the signal into the time domain. To achieve this, the IFFT stage 16 processes N symbols at a time, where N is the number of subcarriers in the OFDM system. Each of the N input symbols has a symbol period of T seconds. Each input symbol acts like a complex weight for a corresponding sinusoidal basis function. Since the input symbols are complex, their values determine both amplitude and phase of the sinusoid for that subcarrier. The IFFT output corresponds to the sum of all N sinusoids. Thus, the IFFT stage 16 provides a simple way to modulate data onto N orthogonal subcarriers. The block of N output samples of the IFFT stage 16 makes up a single OFDM symbol. The length of the OFDM symbol is N·T.

After some additional processing, the time-domain signal output from the IFFT stage 16 is transmitted across a transmission channel to the receiver 20. At the receiver 20, the FFT stage 26 is used to process the received signal in an inverse manner after some initial processing stages, to bring it back into the frequency domain. The converted or transformed signal is subjected to some further processing including a combined de-interleaving and bit reordering stage 22 and other preceding operations 24 to obtain the original source symbols.

The present OFDM system according to one embodiment of the invention comprises frequency-domain interleaving, which means that the data is interleaved in the combined interleaving and bit reordering stage 12 of the transmitter 10 before it is transferred to the time domain by the IFFT stage 16. In the receiver 20, the data is transferred from time to frequency domain by the FFT stage 26 before it is de-interleaved in the combined de-interleaving and bit reordering stage 22. De-interleaving is required to reverse the interleaving applied in the transmitter 10.

The Cooley-Tukey algorithm is disclosed in James W. Cooley and John W. Tukey, “An algorithm for the machine calculation of complex Fourier series,” Math. Comput. 19, 297-301 (1965). This is a divide and conquer algorithm that recursively breaks down a digital Fourier transformation (DFT) of any composite size N=N₁N₂ into many smaller DFTs of sizes N₁ and N₂, along with O(n) multiplications by complex roots of unity traditionally called twiddle factors. If N₁ is the radix, it is called a DIT algorithm, whereas if N₂ is the radix, it is called a DIF algorithm. One example of use of the Cooley-Tukey algorithm is to divide the transform into two pieces of size n/2 at each step, and is therefore limited to power-of-two sizes, but any factorization can be used in general. These are called the radix-2 and mixed-radix cases, respectively (and other variants have their own names as well).

According to one embodiment, the idea is to use a fast radix-2 single path delay feedback in the IFFT/FFT stages 16, 26 and combine a non-reordered and thus bit-reversed output of the FFT stage 26 with the de-interleaving scheme in the combined de-interleaving and reordering stage 22 of the receiver 20. Additionally, a non-reordered and thus bit-reversed input of the IFFT stage 16 of the transmitter 10 is combined with interleaving scheme of the combined interleaving and bit reordering stage 12. This means, no reordering is performed in the IFFT and FFT stages 16, 26, but this processing is shifted to and combined with the processing at the correspondingly modified interleaver/de-interleaver functionality of the combined interleaving and bit reordering stage 12 and the combined de-interleaving and bit reordering stage 22, respectively. Through this measure, the delay of the two IFFT and IFFT stages 16, 26 in the receiver 10 and transmitter 20, respectively, can be reduced to two OFDM symbols and also memory requirements are minimized.

FIG. 2 shows a schematic signal flow graph for an exemplary DIF implementation of a radix-2 8-point FFT processing, as an example of the processing performed by the FFT stage 26. The processing includes three stages of basic butterfly units which consist of complex multiplications and additions, where arrow heads and other implicit details have been removed. In particular, the first stage (N=8) on the left side performs a bifurcation of data into the second stage in the middle portion. Thus, the second stage comprises two FFT blocks, each of N=4. The second stage performs another bifurcation of data into the third stage on the right side. Now, the third stage comprises four FFT blocks, each of single butterfly units. As can be gathered from the numbers at the output terminals after the third stage, the inherent shuffling of data leads to a bit-reversed representation of the processed data at the output terminals. Normally, this representation would require a further reordering stage with a buffer memory for bit-reversed addressing, which introduces latency and requires additional memory. However, according to one embodiment of the invention, the required reordering is covered by the modified de-interleaving processing at the combined deinterleaving and bit reordering stage 22, so that no additional memory space and processing stage is required at the FFT stage 26.

The same applies to the similar processing at the IFFT stage 16 on the transmitter side, where the required reordering is covered by the modified interleaving processing at the combined interleaving and bit reordering stage 12, so that no additional memory space and processing stage is required at the IFFT stage 16.

It is apparent that this advantage is not restricted to the specific radix-2 processing shown in FIG. 2, but can be achieved in connection with any FFT or IFFT processing which requires subsequent reordering of bits or symbols. In particular, any other radix-2^{v} processing (e.g., radix-4, radix-8, etc.) could be used in the IFFT stage 16 and the FFT stage 26, while a corresponding reordering scheme is introduced to the interleaving and de-interleaving processing, respectively.

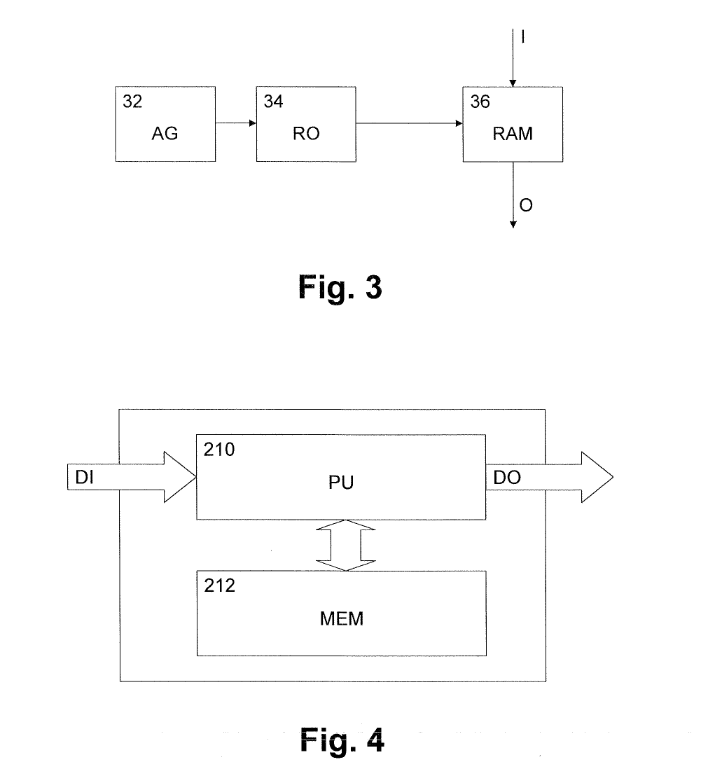

FIG. 3 shows a schematic block diagram of basic exemplary functional blocks which may be provided in the combined interleaving and bit reordering stage 12 and the combined de-interleaving and bit reordering stage 22. The interleaving and de-interleaving processing can be achieved by writing into and subsequently reading from a memory table 36 (e.g., random access memory (RAM)) in respective different orders to change the data or symbol sequence in a desired manner. The writing and reading order can be determined by an address generator 32 which generates writing and reading addresses in accordance with the desired writing and reading order, respectively. Additionally, the combined bit reordering functionality is indicated by the additional reordering functionality or unit 34, which may for example selectively reverse the bit sequence of the binary address generated by the address generator during the reading or writing operation, to thereby obtain the desired bit reordering processing without requiring any additionally memory space.

Of course, other address modifications may be introduced depending on the required reordering processing. Moreover, the functionality of the reordering unit 34 may be incorporated into the address generator 32.

Additionally, it is noted that the functionalities described in connection with FIGS. 1 to 3 may be implemented as discrete hardware, integrated circuits (chip devices), signal processing units, or modules. Alternatively, they may be implemented as software routines or programs controlling a processor or computer device to perform the processing steps of the above functionalities.

FIG. 4 shows a schematic block diagram of a software-based implementation of an embodiment of the invention. Here, the processing of at least blocks 12 and 16 of the transmitter 10 and the processing of at least blocks 22 and 26 of the receiver 20 is performed by a respective processing unit 210, which may be any processor or computer device with a control unit which performs control based on a software routines of a control program stored in a memory 212 provided in or at the transmitter and the receiver 20. Program code instructions are fetched from the memory 212 and are loaded to the control unit of the processing unit 210 in order to perform the processing steps of the above functionalities described in connection with FIGS. 1 to 3. These processing steps may be performed on the basis of input data DI and may generate output data DO, wherein the input and output data DI, DO may related to the input and output symbols described above.

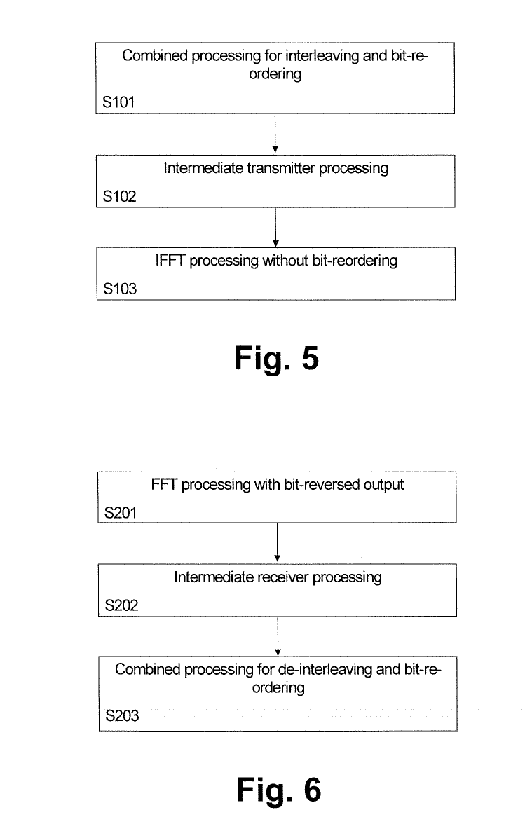

FIGS. 5 and 6 show respective basic flow diagrams of the signal processing performed in the transmitter 10 and the receiver 20, respectively.

According to FIG. 5, a combined processing is applied in step S101 to the input source symbols applied to the transmitter 10, to thereby introduce interleaving and bit-reordering into the data sequence. Then, the interleaved and reordered data sequence is subjected to an intermediate transmitter processing in step S102. Then, in step S103, a “shortened” IFFT processing without bit-reordering processing is performed. Due to the fact that bit-reordering has already been introduced in the previous step S101, a correct data sequence is obtained at the output of the transmitter 10 and supplied to the transmission channel.

According to FIG. 6, a received data sequence is subjected in step S201 to “shortened” FFT processing without bit-reordering processing in the receiver 20. Thus, an incorrect bit-reversed data sequence is subjected to intermediate receiver processing in step S 202. Then, in step S203, combined de-interleaving and bit-reordering processing is applied to the bit-reversed data sequence, so that finally a correct data sequence is again obtained at the output of the receiver 20.

The approach described above leads to a shorter computation time and reduced memory requirements for the combined FFT and de-interleaving operation at the receiver 20. The same applies to the combined interleaving and IFFT operation at the transmitter 10.

Moreover, as it is also possible to use the FFT with a bit-reversed input and the IFFT with a bit-reversed output, the proposed scheme can also be used for systems with time-domain interleaving. Of course, a receiver, which is using this scheme, is still able to operate correctly in a system with a transmitter, which does not use this scheme—and vice versa. This also applies to a transmitter following the scheme.

In summary, signal processing methods and apparatuses for reducing latency in fast Fourier transformation (FFT) related systems have been described. In a first processing direction, an interleaving processing is performed to obtain an interleaved data sequence which is then subjected to an IFFT processing, wherein the interleaving processing comprises a bit re-ordering processing of the IFFT processing. In an opposite second processing direction, an FFT processing is performed with a bit-reversed output data sequence which is then subjected to a de-interleaving processing, wherein the de-interleaving processing comprises a bit re-ordering processing required for reordering said bit-reversed output data sequence. Due to the fact that the reordering processing is incorporated into the interleaving/de-interleaving processing, latency can be reduced and memory space can be saved.

The preferred embodiments can be used in any FFT-related processing environment, for example in wireless access networks, such an WLAN or WIMAX networks, or alternatively in any other signal processing environment which provides a combination of interleaving or de-interleaving processing and FFT or IFFT processing. The preferred embodiments may thus vary within the scope of the attached claims.

1. A signal processing method comprising:
performing an interleaving processing to obtain an interleaved data sequence; and
subjecting said interleaved data sequence to an inverse fast Fourier transformation processing;
wherein said interleaving processing comprises a bit re-ordering processing of said inverse fast Fourier transformation processing.

2. A signal processing method comprising:
performing a fast Fourier transformation processing with a bit-reversed output data sequence; and
subjecting said output data sequence to a de-interleaving processing;
wherein said de-interleaving processing comprises a bit re-ordering processing required for reordering said bit-reversed output data sequence.

3. The method according to claim 1, wherein said bit re-ordering processing is performed by modifying a memory table.

4. The method according to claim 3, wherein said modifying is directed to an address generation for addressing said memory table.

5. A signal processing module comprising:
interleaving means for performing an interleaving processing to obtain an interleaved data sequence; and
transformation means for subjecting said interleaved data sequence to an inverse fast Fourier transformation processing;
wherein said interleaving means are configured to perform a bit reordering processing of said inverse fast Fourier transformation processing.

6. A signal processing module comprising:
transformation means for performing a fast Fourier transformation processing with a bit-reversed output data sequence; and
de-interleaving means for subjecting said output data sequence to a deinterleaving processing;
wherein said de-interleaving means are configured to perform a bit reordering processing required for reordering said bit-reversed output data sequence.

7. The signal processing module according to claim 5, wherein said transformation means is configured to process an orthogonal frequency division multiplexing signal.

8. The signal processing module according to claim 5, wherein said interleaving means comprises modifying means configured to modify a memory table so as to perform said bit reordering processing.

9. The signal processing module according to claim 6, wherein said deinterleaving means comprises modifying means configured to modify a memory table so as to perform said bit reordering processing.

10. The signal processing module according to claim 9, wherein said modifying means is configured to modify address generation for said memory table.

11. A transmission apparatus comprising a signal processing module according to claim 5.

12. The transmission apparatus according to claim 11, wherein said transmission apparatus comprises an orthogonal frequency division multiplexing transmitter.

13. A receiver apparatus comprising a signal processing module according to claim 6.

14. The receiving apparatus according to claim 13, wherein said transmission apparatus comprises an orthogonal frequency division multiplexing receiver.

15. A base station device comprising at least one of a transmission apparatus according to claim 11.

16. A base station device comprising a receiving apparatus according to claim 13.

17. A terminal device comprising at least one of a transmission apparatus according to claim 11.

18. A terminal device comprising a receiving apparatus according to claim 13.

19. A chip device comprising a signal processing module according to claim 5.

20. A chip device comprising a signal processing module according to claim 6.

21. A computer program product comprising code means for generating the steps of method claim 1 when run a computer device.

22. A computer program product comprising code means for generating the steps of method claim 2 when run a computer device.
